(19) United States
(12) Patent Application Publication
(10) Pub. No.: US 2026/0220728 A1
(43) Pub. Date: Jul. 30, 2026

(54) METHODS AND SYSTEMS FACILITATING COURSE REGISTRATION, ENROLLMENT AND PAYMENT

(71) Applicant: D2L Corporation, Kitchener (CA)

(72) Inventors: John Baker, Kitchener (CA); Brian Cepuran, Kitchener (CA); Jeremy Auger, Kitchener (CA)

(21) Appl. No.: 19/647,057

(22) Filed: Apr. 14, 2026

Related U.S. Application Data
(63) Continuation of application No. 18/103,555, filed on Jan. 31, 2023, now abandoned.
(60) Provisional application No. 63/304,867, filed on Jan. 31, 2022.

(51) Int. Cl. G06Q 50/20

(52) U.S. Cl. CPC G06Q 50/2053

(57) ABSTRACT

Disclosed herein are computer implemented methods and systems of electronic course registration and payment, wherein the computer comprises a processor and a memory coupled to the processor and configured to store instructions executable by the processor to perform. The system and method disclose identifying a pathway for a user based on one or more development conditions, the pathway including at least one electronic course, upon determining at least one electronic course within the pathway, recommending the at least one electronic course to the user for registration, and confirming registration for the at least one electronic course, wherein the user is pre-approved for the at least one electronic course within the pathway.

### CROSS-REFERENCE TO RELATED APPLICATIONS

This application is a continuation of US Application No. 18/103,555 filed January 31, 2023 which claims the benefit of U.S. Provisional Patent Application No. 63/304,867 filed on January 31, 2022. The entire contents of U.S. Provisional Patent Application No. 63/304,867 and US Application No. 18/103,555 are hereby incorporated herein by reference for all purposes.

### FIELD

Various embodiments are described herein that generally relate to methods and systems for electronic course registration and payment, and in particular to create recommended pathways including at least one course for registration by a user based on development conditions and user information.

### INTRODUCTION

The following is not an admission that anything discussed below is part of the prior art or part of the common general knowledge of a person skilled in the art.

Many web-based systems, whether internal or external, provide user interfaces for receiving inputs from users. Electronic learning (also known as “e-Learning” or “eLearning”) systems, for example, can include such user interfaces.

Electronic learning generally refers to education or learning where users (e.g., learners, instructors, administrative staff, teaching assistants) engage in education related activities using computers and other computing devices. For example, learners may enroll or participate in a course or program of study offered by an educational institution (e.g., a college, university or grade school) through a web interface that is accessible over the Internet. Similarly, learners may receive assignments electronically, participate in group work and projects by collaborating online, and be graded based on assignments and examinations that are submitted, for example, using an electronic submission tool.

Electronic learning is not limited to use by educational institutions. Electronic learning may be used in other environments, such as government and corporations. For example, employees at a regional branch office of a corporation may use electronic learning to participate in a training course offered by another office, or even a third-party provider. As a result, the employees at the regional branch office can participate in the training course without having to travel to the site providing the training course. Travel time and costs can be reduced and conserved.

Furthermore, because course materials can be offered and consumed electronically, there are fewer restrictions on learning on the job. For example, the number of employees that can be enrolled in a particular course may be practically limitless, as there may be no requirement for physical facilities to house the employees during courses. Courses may be recorded and accessed at varying time (e.g. at different times that are convenient for different users), thus accommodating users with varying schedules, and allowing users to be enrolled in multiple courses that might have a scheduling conflict when offered using traditional techniques.

Despite the effectiveness of electronic learning systems, organizations utilizing such systems may be at a disadvantage when trying to organize the courses of employees and staff of the organizations. Organizations and employees alike may have development pathways for learning in accordance with

Accordingly, the inventors have identified a need for a method and system that attempt to address at least some of the above-identified challenges.

### SUMMARY OF SOME EMBODIMENTS

In a first aspect, a computer implemented method of electronic course registration and payment, wherein the computer comprises a processor and a memory coupled to the processor and configured to store instructions executable by the processor to perform the method comprising identifying a pathway for a user based on one or more development conditions, the pathway including at least one electronic course, upon determining at least one electronic course within the pathway, recommending the at least one electronic course to the user for registration, and confirming registration for the at least one electronic course, wherein the user is pre-approved for the at least one electronic course within the pathway.

In accordance with some embodiments, the one or more development conditions include objectives of an organization, objectives of the user, and objectives of a team within the organization.

In accordance with some embodiments, the method further includes identifying the pathway for the user based on one or more development conditions comprises reviewing, from the memory, electronic courses registered for by the user, assessing the one or more development conditions of the user, determining one or more electronic courses based on the electronic courses registered for by the user and the development conditions and selecting the pathway based on the one or more electronic courses determined.

In accordance with some embodiments, payment for the at least one electronic course is authorized.

In accordance with some embodiments, the method further includes identifying a second pathway for a user based on objectives of an organization.

In accordance with some embodiments, the computer further comprises a context engine configured to provide a manager with data on the pathway identified for the user.

In accordance with some embodiments, the context engine is further configured to output to the manager the at least one electronic course or pathway for the user, and request an input from the manager to approve or disapprove the output electronic course or pathway.

In accordance with some embodiments, the context engine comprises an artificial intelligence (AI) model, the AI model being trained with user data, historical data, and other information, wherein the AI model provides alignment between the at least one electronic course and the development conditions.

In accordance with some embodiments, the context engine is further configured to review, from the memory, historical data, user data and other information, assess the one or more development conditions of the user and the organization, determine potential pathways for the user based on alignment of the historical data, user data, other information and development conditions, and recommend, based on the potential pathways determined, at least one electronic course for the user to register for.

In accordance with some embodiments, the context engine is further configured to notify the user of the at least one electronic course recommended by the AI model.

In another aspect, embodiments described herein may provide a system for facilitating registration and payment of electronic courses, the system comprising one or more computing devices that communicate over a network, at least one computing device comprising a graphical user interface for providing data to the system and outputting data to a user, and a server in electronic communication with the one or more computing devices. The server is configured to identify a pathway for a user based on one or more development conditions, the pathway including at least one electronic course, recommend, based on the identified pathway, the at least one electronic course to the user, and confirming registration for the user of the at least one electronic course within the pathway.

In accordance with some embodiments, the one or more development conditions include objectives of an organization, objectives of the user, and objectives of a team within the organization.

In accordance with some embodiments, identifying the pathway for the user based on one or more development conditions comprises reviewing, from the memory, electronic courses registered for by the user, assessing the one or more development conditions of the user, determining one or more electronic courses based on the electronic courses registered for by the user and the development conditions, and selecting the pathway based on the one or more electronic courses determined.

In accordance with some embodiments, payment for the at least one electronic course is authorized.

In accordance with some embodiments, the server is further configured to identify a second pathway for a user based on objectives of an organization.

In accordance with some embodiments, the server further comprises a context engine configured to provide a manager with data on the pathway identified for the user.

In accordance with some embodiments, the context engine is further configured to output to the manager the at least one electronic course or pathway for the user, and request an input from the manager to approve or disapprove the output electronic course or pathway.

In accordance with some embodiments, the context engine comprises an artificial intelligence (AI) model, the AI model being trained with user data, historical data, and other information, wherein the AI model provides alignment between the at least one electronic course and the development conditions.

In accordance with some embodiments, the context engine reviews, from the memory, historical data, user data and other information, assesses the one or more development conditions of the user and the organization, determines potential pathways for the user based on alignment of the historical data, user data, other information and development conditions, and recommends, based on the potential pathways determined, at least one electronic course for the user to register for.

In accordance with some embodiments, the context engine is further configured to notify the user of the at least one electronic course recommended by the AI model.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a block diagram illustrating an example embodiment of an education system for providing electronic learning that incorporates a context engine according to one embodiment;

FIG. 2 is a block diagram illustrating the context engine shown in FIG. 1;

FIG. 3 is a flow chart illustrating an exemplary method for recommending pathways and/or courses for registration by a user according to one embodiment;

FIGS. 4A and 4B are screenshots of a browser application, where FIG. 4A shows a login screen into the electronic learning system of FIG. 1 and FIG. 4B shows the home screen of the electronic learning system;

FIGS. 5A and 5B are screenshots of a browser application, where FIG. 5A shows, of the electronic learning system of FIG. 1, a registration interface from the user perspective and FIG. 5B shows a registration interface from the management perspective;

FIG. 6 is a screenshot of a browser application of the electronic learning system of FIG. 1 showing a pathway interface from the management perspective; and

FIG. 7 is a flow chart of an example embodiment of an electronic learning method for electronic course registration.

The drawings included herewith are for illustrating various examples of articles, systems, and methods of the teachings of the preset specification and are not intended to limit the scope of what is taught in any way. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps, or omitted for repeating instances of like features.

### DESCRIPTION OF EXAMPLE EMBODIMENTS

Various apparatuses will be described below to provide an example of one or more embodiments. No embodiment described below limits any claims and any claims may cover apparatuses that differ from those described below. The claims are not limited to apparatuses, methods or systems having all of the features of any one apparatus, method, or system described below or to features common to multiple or all of the apparatuses, methods and systems described below.

It is possible that an apparatus, system or method described herein is not an embodiment of any claim. Any embodiment disclosed herein that is not claimed in this document may be the subject matter of another protective instrument, for example, a continuing patent application, and the applicants, inventors or owners do not intend to abandon, disclaim or dedicate to the public any such embodiment merely by its disclosure in this document.

The terms "including", "comprising", and variations thereof mean "including but not limited to", unless expressly specified otherwise. A listing of items does not imply that any or all of the items are mutually exclusive, unless expressly specified otherwise. The terms "a", "an", and "the" mean "one or more", unless expressly specified otherwise.

Some elements herein may be identified by a part number, which is composed of a base number followed by an alphabetical or subscript-numerical suffix (e.g., 112a, or 1121). Multiple elements herein may be identified by part numbers that share a base number in common and that differ by their suffixes (e.g., 1121, 1122, and 1123). Elements with a common base number may in some cases be referred to collectively or generically using the base number without a suffix (e.g., 112).

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof of X, Y, and Z.

The embodiments of the systems and methods described herein may be implemented in hardware or software, or a combination of both. In some cases, embodiments may be implemented in one or more computer programs executing on one or more programmable computing devices comprising at least one processor, a data storage component (including volatile memory or non-volatile memory or other data storage elements or combination thereof) and at least one communication interface.

For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

In some embodiments, each program may be implemented in a high level procedural or object-oriented programming and/or scripting language to communicate with a computer system. However, the programs can be implemented in assembly or machine language, if desired. In any case, the language may be a compiled or interpreted language.

Furthermore, the systems and methods of the described embodiments are capable of being distributed in a computer program product including a physical, non-transitory computer readable medium that bears computer usable instructions from one or more processors. The medium may be provided in various forms, including one or more diskettes, compact disks, tapes, chips, magnetic, volatile memory, non-volatile memory, and electronic storage media, and the like. The computer useable instructions may also be in various forms, including compiled and non-compiled code.

In some examples, similar references may be used in different figures to denote similar components. In some examples, like features may only be labeled in one instance for simplicity and clarity of the drawings.

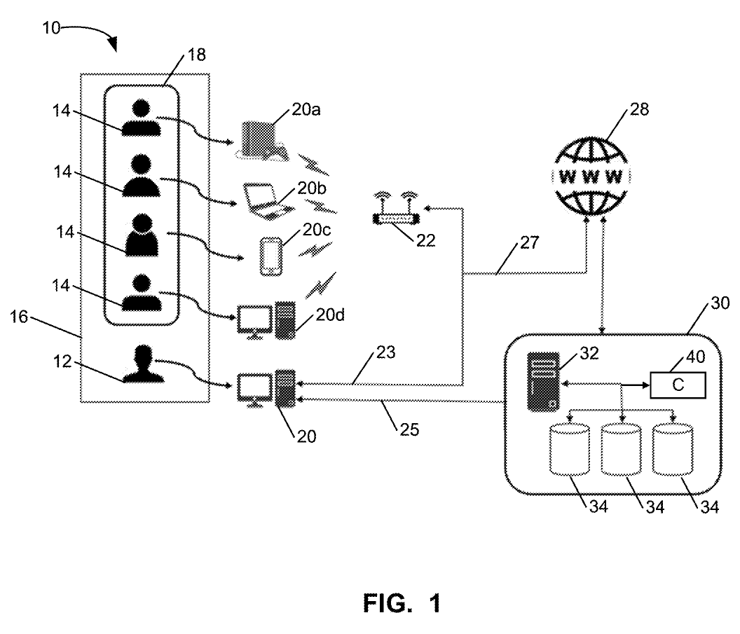

Referring now to FIG. 1, illustrated therein is a schematic diagram 10 of components interacting with an electronic learning system 30 according to some embodiments.

As shown in the schematic diagram 10, one or more users 12, 14 may access the electronic learning system 30 to participate in, create, and consume electronic learning services, including educational content such as courses. In some cases, the electronic learning system 30 may be part of (or associated with) a traditional “brick and mortar” education institution (e.g. a grade school, university or college), another entity that provides education services (e.g. an online university, a company that specialized in offering training courses, an organization that has a training department, etc.), or may be an independent service provider (e.g. for providing individual electronic learning).

It should be understood that a course is not limited to formal courses offered by formal educational institutions. The course may include any form of learning instruction offered by an entity of any type. For example, the course may be a training seminar at a company for a group of employees or a professional certification program (e.g. Project Management Professional™ (PMP), Certified Management Accountants (CMA), etc.) with a number of intended participants.

In some embodiments, one or more education groups 16 can be defined to include one or more users 12, 14. For example, as shown in FIG. 1, the users 12, 14 may be grouped together in an educational group 16. The education group 16 can be associated with a particular course (e.g. History 101 or French 254, etc.), for example. The education group 16 can include different types of users. A first user 12 can be responsible for organizing and/or teaching the course (e.g. developing lectures, preparing assignments, creating educational content, etc.), such as an instructor or course moderator. The other users 14 can be consumers of the course content, such as students.

In some examples, the users 12, 14 may be associated with more than one education group 16 (e.g. some users 14 may be enrolled in more than one course, another example user 12 may be a student enrolled in one course and an instructor responsible for teaching another course, a further example user 12 may be a manager of an organization responsible for overseeing higher learning in the company, and so on).

In some examples, educational sub-groups 18 may also be formed. For example, the users 14 shown in FIG. 1 form an education sub-group 18. The education sub-group 18 may be formed in relation to a particular project or assignment (e.g. education sub-group 18 may be a lab group) or based on other criteria. In some embodiments, due to the nature of electronic learning, the users 14 in a particular educational sub-group 18 may not need to meet in person but may collaborate together using various tools provided by the electronic learning system.

In some embodiments, other education groups 16 or education sub-groups 18 could include users 14 that share common interests (e.g. interest in a particular sport), that participate in common activities (e.g. users that are members of a choir or a club), and/or have similar attributes (e.g. users that are male, users under twenty-one years of age, etc.).

Communication between the users 12, 14 and the electronic learning system 30 can occur either directly or indirectly using one or more suitable computing devices. For example, the user 12 may use a computing device 20 having one or more device processors such as a desktop computer that has at least one input device (e.g. a keyboard and a mouse) and at least one output device (e.g. a display screen and speakers).

The computing device 20 can generally be any suitable device for facilitating communication between the users 12, 14 and the electronic learning system 30. For example, the computing device 20 could be wirelessly coupled to an access point 22 (e.g. a wireless router, a cellular communications tower, etc.). The computing devices 20 can be any electronic device, such as a game console 20a, a laptop 20b, a wirelessly enabled personal data assistant (PDA) or smartphone 20c, or a computer terminal 20d. The computing device 20 could be coupled to the access point 22 over a wired connection 23.

The computing devices 20 may communicate with the electronic learning system 30 suitable communication channels.

The computing devices 20 may be any networked device operable to connect to the network 28. A networked device is a device capable of communicating with other devices through a network such as the network 28. A network device may couple to the network 28 through a wired or wireless connection.

As noted, these computing devices 20 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. These computing devices 20 may be handheld and/or wearable by the user.

In some embodiments, these computing devices may be a laptop 20b, or a smartphone 20c equipped with a network adapter for connecting to the Internet. In some embodiments, the connection request initiated from the computing devices 20b, 20c may be initiated from a browser application and directed at the browser-based communications application on the electronic learning system 30.

For example, the computing devices 20 may communicate with the electronic learning system 30 via the network 28. The network 28 may include a local area network (LAN) (e.g., an intranet) and/or external network (e.g., the Internet). For example, the computing devices 20 may access the network 28 by using a browser application provided on the computing devices 20 to access one or more web pages presented over the Internet via a data connection 27.

The network 28 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the computing devices 20 and the electronic learning system 30, for example.

In some examples, the electronic learning system 30 may authenticate an identity of one or more of the users 12, 14 prior to granting the user 12, 14 access to the electronic learning system 30. For example, the electronic learning system 30 may require the users 12, 14 to provide identifying information (e.g., a login name and/or a password) in order to gain access to the electronic learning system 30.

In some examples, the electronic learning system 30 may allow certain users 12, 14, such as guest users, access to the electronic learning system 30 without requiring authentication information to be provided by those guest users. Such guest users may be provided with limited access, such as the ability to review one or more components of the course to decide whether they would like to participate in the course but without the ability to post comments or upload electronic files.

In some embodiments, the electronic learning system 30 may communicate with the access point 22 via a data connection 25 established over the LAN. Alternatively, the electronic learning system 30 may communicate with the access point 22 via the Internet or another external data communications network. For example, one user 14 may use the laptop 20b to browse to a webpage (e.g. a course page) that displays elements of the electronic learning system 30, or an electronic form for providing inputs to the electronic learning system 30.

The electronic learning system 30 can include one or more components for providing electronic learning services. It will be understood that in some embodiments, each of the one or more components for providing electronic learning services may be combined into fewer number of components or may be separated into further components. Furthermore, the one or more components in the electronic learning system 30 may be implemented in software or hardware, or a combination of software and hardware.

For example, the electronic learning system 30 can include one or more processing components, such as computing server 32. Computing server 32 can include one or more processor. The processors provided at the computing server 32 can be referred to as “system processors” while processors provided at computing devices 20 can be referred to as “device processors”. The computing server 32 may be a computing device 20 (e.g. a laptop or personal computer).

It will be understood that although one computing server 32 is shown in FIG. 1, more than one computing servers 32 may be provided. The computing servers 32 may be located locally together or distributed over a wide geographic area and connected via the network 28.

The system processors may be configured to control the operation of the electronic learning system 30. The system processors can initiate and manage the operations of each of the other components in the electronic learning system 30. The system processor may also determine, based on received data, stored data and/or user preferences, how the electronic learning system 30 may generally operate or how the contents, such as course registration information, is provided to a display of the computing devices 20 in accordance with the described methods.

The system processor may be any suitable processors, controllers or digital signal processors that can provide sufficient processing power depending on the configuration, purposes and requirements of the electronic learning system 30. In some embodiments, the system processor can include more than one processor with each processor being configured to perform different dedicated tasks.

In some embodiments, the computing server 32 can transmit data (e.g. electronic files such as web pages) over the network 28 to the computing devices 20. The data may include electronic files, such as webpages with course information, associated with the electronic learning system 30. Once the data is received at the computing devices 20, the device processors can operate to display the received data.

The electronic learning system 30 may also include one or more data storage components 34 that are in electronic communication with the computing server 32. The data storage components 34 can include RAM, ROM, one or more hard drives, one or more flash drives, or some other suitable data storage elements such as disk drives, etc. The data storage components 34 may include one or more databases, such as a relational database (e.g., a SQL database), for example.

The data storage components 34 can store various data associated with the operation of the electronic learning system 30. For example, course data, such as data related to a course's framework, educational content, and/or records of assessments, may be stored at the data storage components 34. The data storage components 34 may also store user data, which includes information associated with the users 12, 14. The user data may include a user profile for each user 12, 14, for example. The user profile may include personal information (e.g., name, gender, age, birthdate, contact information, interests, hobbies, etc.), authentication information to the electronic learning system 30 (e.g., login identifier and password), and educational information (e.g., which courses that user is enrolled in, the user type, course content preferences, etc.).

The data storage components 34 may also store data associated with the electronic forms that are provided by the electronic learning system 30. The form data may include the electronic forms themselves (e.g., data fields, control fields, etc.) and the various factors and thresholds associated with determining whether to provide a transient control component, as will be described. Data received via the various electronic forms can also be stored in the data storage components 34.

The data storage components 34 can store authorization criteria that define the actions that may be taken by certain users 12, 14 with respect to the various educational contents provided by the electronic learning system 30. The authorization criteria can define different security levels for different user types. For example, there can be a security level for an instructing user who is responsible for developing an educational course, teaching it, and assessing work product from the student users for that course. The security level for those instructing users, therefore, can include, at least, full editing permissions to associated course content and access to various components for evaluating the students in the relevant courses.

In some embodiments, some of the authorization criteria may be pre-defined. For example, the authorization criteria can be defined by administrators so that the authorization criteria are consistent for the electronic learning system 30, as a whole. In some further embodiments, the electronic learning system 30 may allow certain users, such as instructors, to vary the pre-defined authorization criteria for certain course contents.

The electronic learning system 30 can also include one or more backup servers. The backup server can store a duplicate of some or all of the data stored on the data storage components 34. The backup server may be desirable for disaster recovery (e.g. to prevent data loss in the event of an event such as a fire, flooding, or theft). It should be understood that although there are no backup servers shown in FIG. 1, one or more backup servers may be provided in the electronic learning system 30. The one or more backup servers can also be provided at the same geographical location as the electronic learning system 30, or one or more different geographical locations.

The electronic learning system 30 can include other components for providing the electronic learning services. For example, the electronic learning system 30 can include a management system that allow users 12, 14 to add and/or drop courses and a communication component that enables communication between the users 12, 14 (e.g., a chat software, etc.). The communication component may also enable the electronic learning system 30 to benefit from tools provided by third-party vendors. The management system may include a tool for organizing and approving course selection by users.

As shown in FIG. 1, the electronic learning system 30 also generally includes a context engine 40, which is operable to generate recommendations on electronic courses for users based on development conditions, as will be discussed further below.

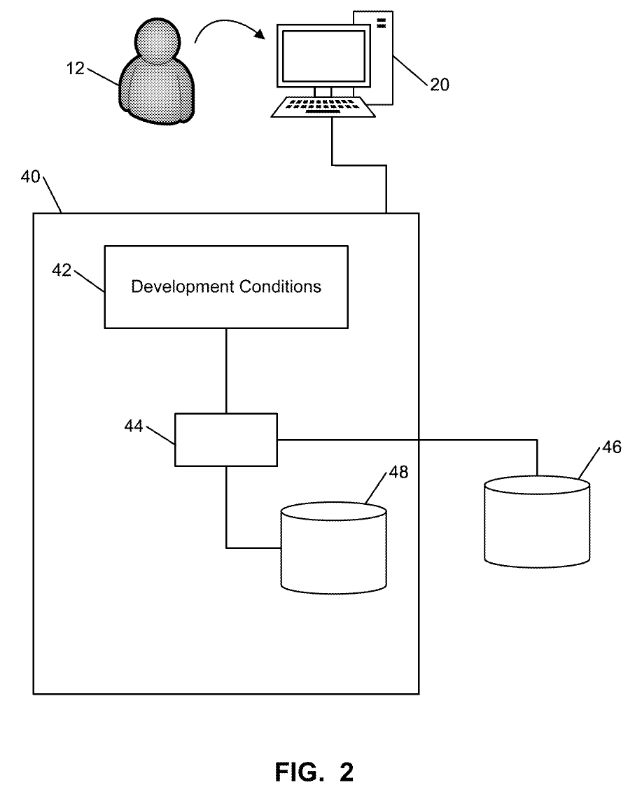

Turning now to FIG. 2, illustrated therein a block diagram of a context engine 40 according to one exemplary embodiment. In this embodiment, the context engine 40 is operable to communicate with the manager 12 via the computing device 20.

The context engine 40 can be an analytics engine or any engine that can perform operations related to understanding, interpretation of, and actions performed related to a set of received data inputs. For example, the context engine 40 can generate one or more predicted likelihoods corresponding to learning pathways suitable for organizational objective and/or employee objectives and aligning such objectives. For example, the context engine 40 can recommend courses suitable for organizational objective and/or employee objectives, making effective use of available resources to accomplish organizational goals, while seeking for ways to reduce cost, and consistently uses and allocates resources to meet objectives.

The context engine 40 can be trained with historical data, including organizational data and employee data. The context engine can generate UI elements and/or graphics data to be provided to a computing device 20. Examples of the context engine 40 that could be used include a plurality of web services and backend applications, including IBM's Watson, Google Cloud Natural Language API, Amazon Lez, and Microsoft Cognitive Services.

The context engine 40 is configured to assist with the recommendation and registration of courses for individual users 14. The context engine 40 may include a machine learning module 44 which may analyze received data on an individual and organization and determine an appropriate pathway for the user 14. The pathway created by the machine learning module may include at least one course. In some embodiments, course information may come from external sources, such as course database 46 managed by the electronic learning system 30, or another database 48 local to the context engine 40, for example.

Development conditions 42 associated with a user 14 may be determined by the context engine 40. The development conditions 42 of a user 14 may assist the context engine 40 in generating pathways and/or courses for that user. Development conditions 42 may include current career position, goal career position, individual career objectives, organizational objectives, and/or objectives of a team within the organization that user 14 is a part of.

In at least one embodiment, the manager 12 may be prompted to select an employee or user 14 from the context engine 40. This may bring forward the individual development conditions 42 of the selected user 14. In some embodiments, the manager 12 may be able to see the individual development conditions 42 of the selected user 14. In some embodiments, the individual development conditions 42 of the selected user 14 may be kept confidential.

The context engine 40 may further comprise a machine learning module 44. The machine learning module 44 may assess individual data related to a user 14 and determine potential pathways for the user 14. Individual data may include development conditions 42 and historical data from the memory in the electronic learning system 30. Historical data may include previous courses taken and/or registered, background education, competencies, competency gaps, current role, and interests of the user 14.

The machine learning module 44 may further take into account information from third parties (e.g. universities) indicating which programs lead into certain skills, tagging of skills/competencies, internet sources using semantic analysis, and/or information pertaining to skill gaps at an industry level when determining individual pathways.

The potential pathways determined by the machine learning module 44 may be electronic content objects. The pathways may be a personalized or individualized set of one or more courses suggested for the user 14. In some embodiments, the pathway may be directed towards the user 14 and their individual goals, such as career goals, in an individualized pathway. In some embodiments, the pathway may be directed towards the user 14 and the goals of the organization that they work for, such as diversity or safety goals, in an organizational pathway. In some embodiments, the pathway may be directed towards the user 14 and the goals of the team within the organization that they are a part of, such as competencies that should be even across the team, in a team pathway. In some embodiments, multiple pathways may be determined for a user 14, where one pathway is an individualized pathway, and a second pathway may be either an organizational or team pathway. In some embodiments, all three pathways may be recommended to a user 14. In some embodiments, pathways may contain a single course. In some embodiments, pathways may contain any number of courses.

Understanding whether a course is suitable for a user 14 can be accomplished based on different information that may be known about the course and the user. For instance, in some embodiments, the course database 46, 48 may store topics and other features of the courses. This could include information such as course title, as well as meta-tags that may have been manually associated with the course and stored in the course database 46, 48.

In some embodiments, the machine learning module 44 may determine one or more courses to recommend to the user 14 based on the historical data, development conditions and other information the machine learning module 44 has received. Once at least one course has been determined, the machine learning module 44 may select a pathway for the user 14 based on the course.

In some embodiments, pathways determined by the machine learning module 44 may be selected from a set of pre-determined pathways. For example, if an individual user 14 has just begun their career, a pre-determined pathway may be selected for the user 14 which sets out courses that are beneficial for an individual within an early stage of their career. Pre-determined pathways may be curated by a manager 12, an organization, or an authorized member of the organization.

In some embodiments, pathways determined by the machine learning module 44 may be curated specifically for the individual. For example, if an individual user 14 wishes to further the training in a specific aspect of work, and the organization requires the user 14 to renew safety training, a pathway may be curated for the user 14 which will further the personal training as well as the safety training.

In some embodiments, the machine learning module 44 may curate a direct pathway for the user. A direct pathway may include only courses that are directly aligned with the pathway. For example, if the organization requires the employees of the organization to each reach an organization wide level of training on a specific subject within the year, a direct pathway for the employees will contain only the courses on the specific subject to allow them to reach the required level. In some embodiments, a first user may require only a single course to reach the required training level and a second user may require, for example, three or more courses to reach the required training. Each user will receive a different pathway, but each pathway may be a direct pathway, where the only courses on the pathway are to achieve a specific goal.

In some embodiments, the machine learning module 44 may curate an indirect pathway for the user. An indirect pathway may include courses that are not directly aligned with the pathway. For example, a user 14 may state that their career goal is to reach a level of their substantive training. The machine learning module 44 may determine this and include one or more courses on the pathway of the user 14 that is not in in direct alignment with the substantive goal. In some embodiments, the machine learning module 44 may include a course that may further the career of the user 14, such as leadership training, that may not be required to complete the level of substantive training.

In the preferred embodiment, the machine learning module 44 outputs the recommended pathway and course information to the context engine 40. If the recommended pathways and/or courses are confirmed by the machine learning module 44 to be direct, the context engine 40 may then confirm the recommended pathways and/or courses and transmit the information directly to user 14 for registration. In said embodiment, the manager 12 or organization is not required to approve the pathways and/or courses for the user 14. As such, the pathways/courses are pre-approved by the context engine 40 and are able to bypass management approval to be transmitted to the user 14. This may provide a streamlined approach to the course registration process, where the manager 12 is not required to take the extra step to approve the pathways and/or courses for the user 14.

In some embodiments, if the recommended pathways and/or courses are confirmed by the machine learning module 44 to be indirect, the context engine 40 may then transmit the recommendations, pathway details and course details to the manager 12. In said embodiment, the manager 12 may have the option to approve the recommended individualized, organizational or team pathway and courses, or decline. If the manager 12 approves the pathways and/or courses, the context engine 40 may then transmit the recommended pathways and/or courses to the user 14 for registration.

In some embodiments, the manager 12 or an authorized member of the organization may input, prior to the analysis by the machine learning module 44, previously approved pathways specific to the organization. For example, if the organization wishes for certain employees to complete WHMIS training and cyber security training, the manager 12 or authorized member may contact the electronic learning system 30 and designate said training as a pathway for all or some employees. In said embodiment, the manager 12 is not required to approve the pathways and/or courses prior to the context engine 40 transmitting them to the user 14 for registration.

The context engine 40 may transmit further information to the manager 12 in relation to the recommended pathways and/or courses for the user 14. For example, the manager 12 may receive background information on the user 14 such as their career goals, individual career objectives, previous completed training, alignment between individual objectives and organizational objectives, or any other information used by the machine learning module 44 to determine the pathways and/or courses.

In some embodiments, reasoning as to why the recommendation is for a pathway or course may be provided to the manager 12. For example, a safety course may be recommended to the user 14 based on the user having hit a certain length of time since they last completed the safety course. In contrast, a user 14 may be recommended to take a sexual harassment course after the organization received a complaint.

The context engine 40 may further include a planning tool. The planning tool may provide the managerial side of the organization with recommended professional development actions and/or courses for the organization as a whole, the organization at a team level, or at the individual level.

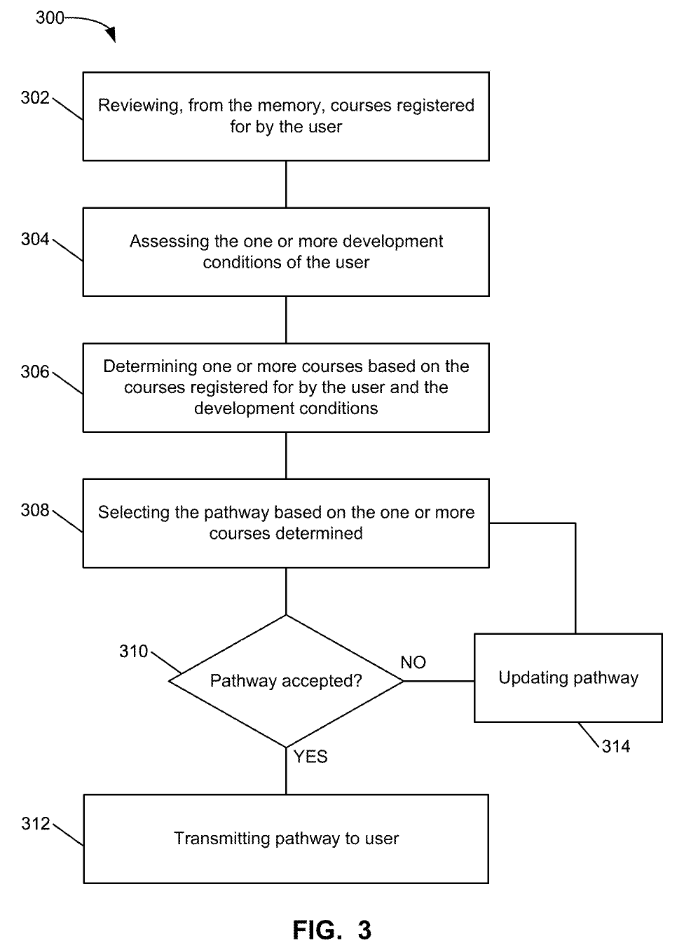

Referring now to FIG. 3, there is shown an example embodiment of a method 300 for recommending electronic courses and pathways to a user 14 in accordance with some embodiments. More particularly, method 300 discloses, in further detail, the process of training the machine learning module 44 to analyze user data and development conditions to determine pathways and courses specific to the user. Method 300 can be performed, for example, by the machine learning module 44 being executed by the context engine 40.

At 302, the machine learning module 44 may review historical data, user data and other information associated with the user 14. The machine learning module 44 may collect this data from the data storage components 34 of the electronic learning system 30. The user data may have been previously collected by the electronic learning system 30 from the user 14 themselves, the manager 12, the organization, or any other source of potential data on the user 14.

At 304, the machine learning module 44 can assess the one or more development conditions of each the user 14 and the organization. The development conditions can include, for example, current career position, goal career position, individual career objectives, organizational objectives, and/or objectives of a team within the organization that user 14 is a part of. The machine learning module 44 may analyze the user data and the development conditions of user 14.

At 306, the machine learning module 44 may determine one or more courses to be recommended to the user 14 based on the historical data on the user 14 and the development conditions of the user 14. Alignment between the recommended course and the development conditions for the user 14 is determined by the machine learning module 44. For example, if the user 14 included in their personal career goals that they wish to reach a certificate level of training in a particular aspect and they have already taken one course on that aspect, the machine learning module 44 may determine that they require a second course in that aspect as well as a side course that would further their understanding of the subject matter and recommend the two courses to the user 14.

At 308, the machine learning module 44 may select a pathway based on the one or more courses that were determined at step 306. Building on the previous example, the subject matter of the courses may be related to project management. The machine learning module 44 may determine that the user 14 wishes to further their management skills and select a project management pathway for the user 14. The project management pathway, for example, may include courses on leadership, project planning, and project execution.

In some embodiments, the selected pathway may be transmitted from the context engine 40 and the machine learning module 44 to the management 12 of the organization.

At 310, the context engine 40 may receive input from the manager 12 about the pathway selected for the user 14. For example, if the manager 12 approves the pathway, then the method 300 proceeds to step 312 and the user 14 will have the opportunity to register for the course. In some embodiments, the manager 12 may approve the pathway and pre-approve the courses for registration. In said embodiment, the user 14 may be notified that the courses have been pre-approved.

At 312, the pathway may be transmitted to a user 14 for the user 14 to register in the course. On the other hand, the user may choose to disregard the recommended course (i.e., by actively ignoring the course recommendation or taking another action).

If, at step 310, the manager 12 does not approve the pathway, the method 300 may proceed to step 314. At 314, the pathway is sent back to the machine learning module 44. The machine learning module 44 may re-assess the courses and/or pathway recommended for the user 14.

In various cases, the machine learning module 44 may take the approval or dis-approval of the pathway from the manager 12 and store it within the context engine 40. As time progresses and data on pathway approval is collected, the machine learning module 44 may be trained to better interpret the historical data, development conditions and user data to suggest pathways that are in alignment with the goals of the individual.

In some embodiments, the method 300 may be iterated to generate trained machine learning modules for different types of course data. Otherwise, a single trained machine learning module may be generated for all types of course data.

Advantageously, the present system allows managers of an organization to pre-approve courses, from which employees can register without further approval. Another advantage of the present system is to allow an employee to one-click enroll in a desired course, which has been pre-approved.

Further, the present system can advantageously provide context to managers with regard to informing and evaluating approval decisions. For example, an artificial intelligence (AI) tool, which includes a trained AI model, can be used to determine alignment of a course with organizational objective and/or employee objectives, making effective use of available resources (employee's time and materials) to accomplish organizational goals, while seeking for ways to reduce cost, and consistently uses and allocates resources to meet objectives. The AI tool can be trained with historical data, including but not limited to organizational metrics, employee surveys, employee evaluation, employee satisfaction data, etc. Furthermore, the AI tool can advantageously determine perfect or near-perfect aligned course pathways between organizational objective and/or employee objectives, which can be automatically approved.

Further, the present system can advantageously provide a managerial planning tool, which at the beginning of year can provide recommended professional development at team level and at individual level. For example, the managerial tool can include the AI tool as described above. The tool can nudge employees to enroll in approved development pathways. A pathway (e.g., learning pathway, course pathway, development pathway, etc.) can be an electronic object or an electronic content that is presented to a user in a graphical user interface of computer device, allowing the user to follow a specified electronic (or virtual) path through the information space. For example, the pathway takes into account the user's profile into the N dimensional total information space. For example, the pathway can be directional, meaning that the user may follow the sequence of the electronic paths (including electronic courses and evaluations). For example, the pathway can provide a completion estimate of a particular value in the context of learning requirements.

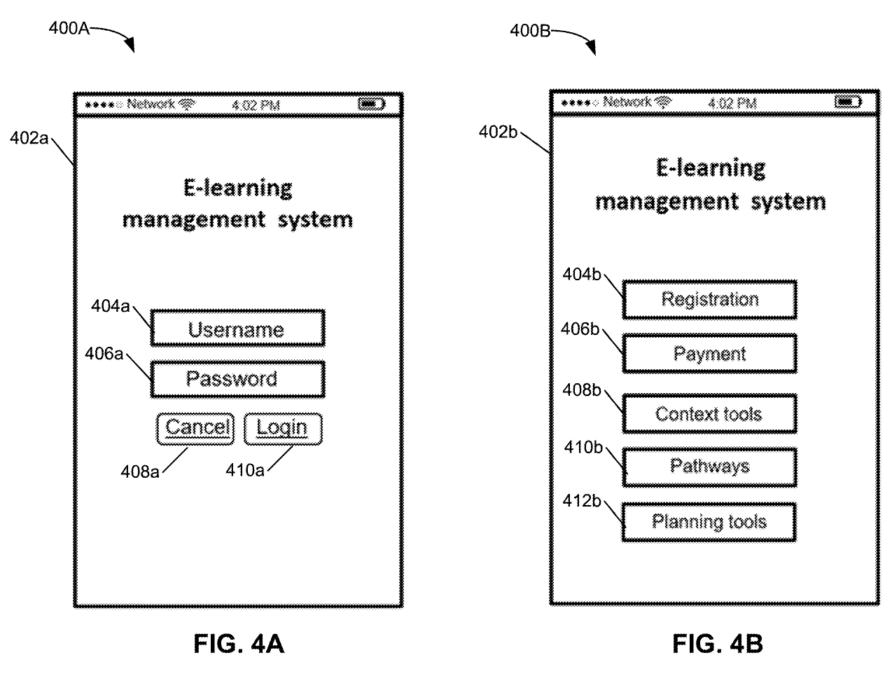

Reference will now be made to FIGS. 4A to 4B, which are screenshots 400A to 400B, respectively, of a browser application showing different portions of the user interface. The user interface may be provided at the computing device 20.

As shown in FIG. 4A, a login screen for the e-learning management system disclosed herein may be provided. The login screen may include fields to enter a username 404a and password 406a, with input options to cancel 408a or login 410a to the e-learning management system. Login screens for the user 14 and management 12 may be the same.

Once past the login screen shown in FIG. 4A, the browser application may show the user an options screen for the e-learning management system, shown in FIG. 4B. The options screen for management 12 may include options of registration 404b, payment 406b, context tools 408b, pathways 410b, and planning tools 412b, or any combination of the options. The options screen for users 14 may include registration 404b, payment 406b, pathways 410b, and planning tools 412b, or any combination of these noted options.

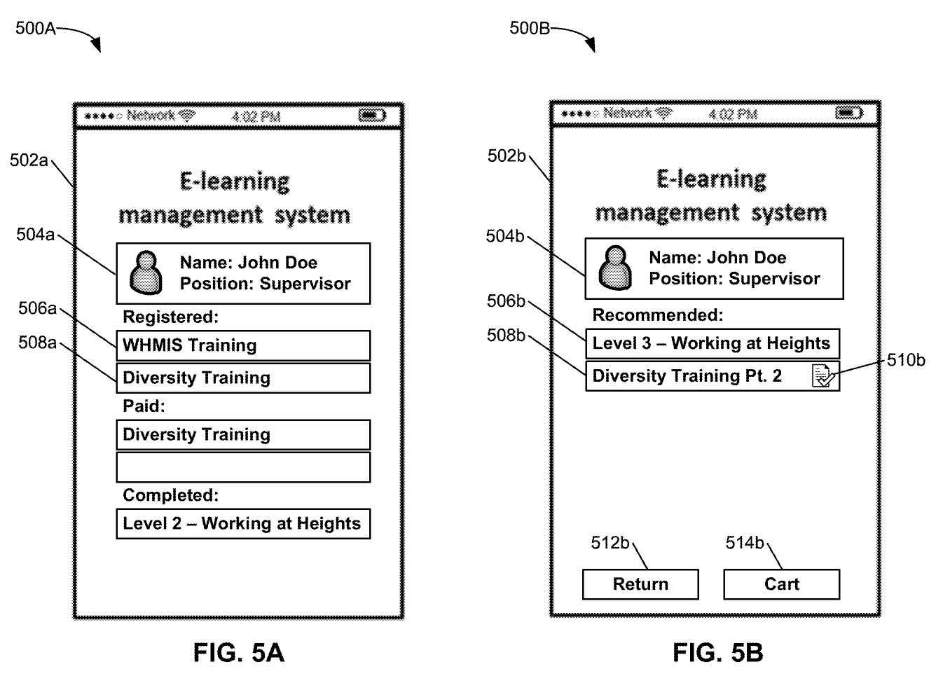

Reference will now be made to FIGS. 5A to 5B, which are screenshots 500A to 500B, respectively, of a browser application showing the management view of the registration screen 502a and the user side of the registration screen 502b.

Registration screen 502a may show management a list of users 14 that have registered for courses. If a user is selected, as shown in FIG. 5A, the name of the user 504a may be shown, as well as each course 506a, 508a that the user 504a has interacted with. It may show the status of the course 506a, 508a, for example, whether the user 504a is registered, paid for, or completed the course.

Registration screen 504a may show the user a list of available courses 506b, 508b that have been recommended by the context engine. The courses available for registration may include a banner 510b to show that the course has been pre-approved. Selection of multiple courses may be possible. Once courses have been selected by the user, the user may have the input options to return 512b or proceed to cart 514b. If the user selects to proceed to cart 514b, the user interface may take the user to a payment screen where the user may input their information to pay for the course.

In some embodiments, the available courses 506, 508 may include information about the course, such as a course description, who is teaching the course, pre-requisite courses, and so on. In some embodiments, this additional course information may be available by “drilling down” into more detail about the course, such as via a hyperlink or pop-up screen that shows information in response to a user action (i.e., clicking on or hovering over the course name).

In some cases, registration in one or more courses could happen automatically. For example, the user could be automatically enrolled in the recommended courses, and then be presented with an option to delete one or more courses.

In some embodiments, registration could happen directly through the context engine 40 or another associated system. In some embodiments, registration could be handled via other methods, such as management or an authorized party of an organization registering a person.

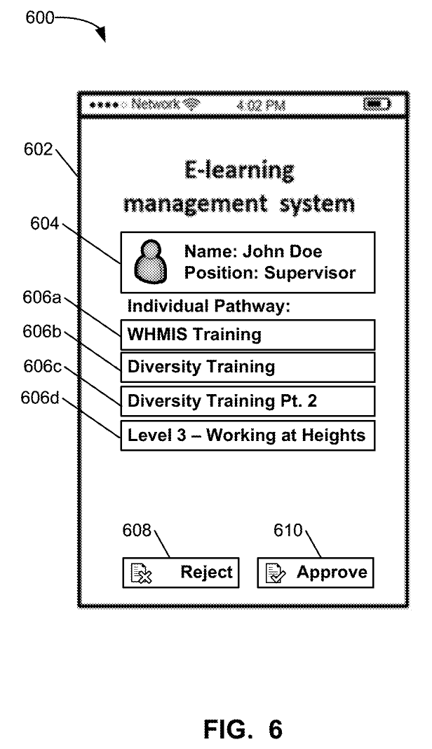

Referring now to FIG. 6, shown therein is a screenshot 600 of a browser application showing the management view of the pathway screen 602.

Pathway screen 602 may show management a particular user 604. When viewing the pathway screen 602, there may be shown an individual pathway such as in FIG. 6, organizational pathways or team pathways that have been recommended by the context engine 40. Each pathway may show at least one course 606a-d, allowing the management to review the courses 606a-d selected for the pathway.

In one embodiment, management may have the input options to reject 608 or approve 610 the pathway for each individual. In another embodiment, management may select a single course 606a. After selection of the single course 606a, management may have the input options to reject 608 or approve 610 the single course 606a, without rejecting 608 the entire pathway.

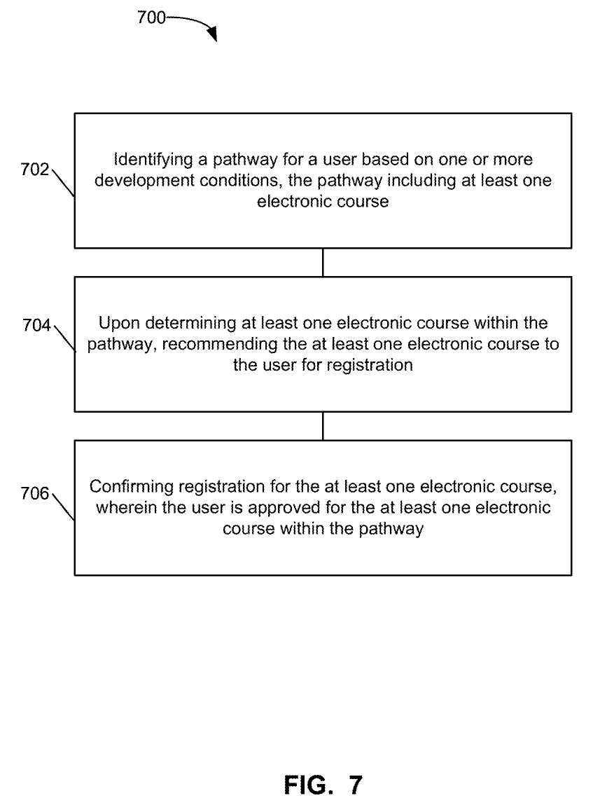

Referring now to FIG. 7, there is shown a flow chart of an electronic learning method 700 for electronic course registration. Method 700 can be performed by a system processor of a computing server 32.

At 702, a pathway is identified for a user 14 based on one or more development conditions, the pathway including at least one electronic course. This may include, for example, identifying historical data, user data or any other information related to the user, and correlating said data with the development conditions of the user 14.

At 704, upon determining at least one course within the pathway, the at least one course is recommended to the user 14 for registration. The course or pathway recommendations could include recommended courses to enroll in and may be provided as one or more lists of the courses. In some embodiments, pathways may be shown to the user 14, the pathway including at least one course.

At 706, registration for the at least one course is accepted, wherein the user 14 is approved for the at least one course within the pathway. As disclosed above, registration for a course and/or pathway may be pre-approved by the context engine 40 or by a manager 12.

Various embodiments have been described herein by way of example only. Various modification and variations may be made to these example embodiments without departing from the spirit and scope of the invention, which is limited only by the appended claims.

1. A computer implemented method of electronic course registration and payment, wherein the computer comprises a processor and a memory coupled to the processor and configured to store instructions executable by the processor to perform the method comprising:
identifying a pathway for a user based on one or more development conditions, the pathway including at least one electronic course;
upon determining at least one electronic course within the pathway, recommending the at least one electronic course to the user for registration; and
confirming registration for the at least one electronic course, wherein the user is pre-approved for the at least one electronic course within the pathway.

2. The method of claim 1, wherein the one or more development conditions include objectives of an organization, objectives of the user, and objectives of a team within the organization.

3. The method of claim 2, wherein identifying the pathway for the user based on one or more development conditions comprises:
reviewing, from the memory, electronic courses registered for by the user;
assessing the one or more development conditions of the user;
determining one or more electronic courses based on the electronic courses registered for by the user and the development conditions; and
selecting the pathway based on the one or more electronic courses determined.

4. The method of claim 1, wherein payment for the at least one electronic course is authorized.

5. The method of claim 1, further comprising identifying a second pathway for a user based on objectives of an organization.

6. The method of claim 1, wherein the computer further comprises a context engine configured to provide a manager with data on the pathway identified for the user.

7. The method of claim 6, wherein the context engine is further configured to:
output to the manager the at least one electronic course or pathway for the user; and
request an input from the manager to approve or disapprove the output electronic course or pathway.

8. The method of claim 6, wherein the context engine comprises an artificial intelligence (AI) model, the AI model being trained with user data, historical data, and other information, wherein the AI model provides alignment between the at least one electronic course and the development conditions.

9. The method of claim 8, wherein the context engine is further configured to:
review, from the memory, historical data, user data and other information;
assess the one or more development conditions of the user and the organization;
determine potential pathways for the user based on alignment of the one or more development conditions with the historical data, user data, and other information; and
recommend, based on the potential pathways determined, at least one electronic course for the user to register for.

10. The method of claim 9, wherein the context engine is further configured to notify the user of the at least one electronic course recommended by the AI model.

11. A system for facilitating registration and payment of electronic courses, the system comprising:
one or more computing devices that communicate over a network, at least one computing device comprising a graphical user interface for providing data to the system and outputting data to a user; and
a server in electronic communication with the one or more computing devices, the server being configured to:
identify a pathway for a user based on one or more development conditions, the pathway including at least one electronic course;
recommend, based on the identified pathway, the at least one electronic course to the user; and
confirm registration for the user of the at least one electronic course within the pathway.

12. The system of claim 11, wherein the one or more development conditions include objectives of an organization, objectives of the user, and objectives of a team within the organization.

13. The system of claim 12, wherein identifying the pathway for the user based on one or more development conditions comprises:
reviewing, from the memory, electronic courses registered for by the user;
assessing the one or more development conditions of the user;
determining one or more electronic courses based on the electronic courses registered for by the user and the development conditions; and
selecting the pathway based on the one or more electronic courses determined.

14. The system of claim 11, wherein payment for the at least one electronic course is authorized.

15. The system of claim 11, wherein the server is further configured to identify a second pathway for a user based on objectives of an organization.

16. The system of claim 11, wherein the server further comprises a context engine configured to provide a manager with data on the pathway identified for the user.

17. The system of claim 16, wherein the context engine is further configured to:
output to the manager the at least one electronic course or pathway for the user; and
request an input from the manager to approve or disapprove the output electronic course or pathway.

18. The system of claim 16, wherein the context engine comprises an artificial intelligence (AI) model, the AI model being trained with user data, historical data, and other information, wherein the AI model provides alignment between the at least one electronic course and the development conditions.

19. The system of claim 18, wherein the context engine is further configured to:
reviews, from the memory, historical data, user data and other information;
assesses the one or more development conditions of the user and the organization;
determines potential pathways for the user based on alignment of the one or more development conditions with the historical data, user data, and other information; and
recommends, based on the potential pathways determined, at least one electronic course for the user to register for.

20. The system of claim 19, wherein the context engine is further configured to notify the user of the at least one electronic course recommended by the AI model.
